(19) United States
(12) Patent Application Publication
(10) Pub. No.: US 2019/0295097 A1
(43) Pub. Date: Sep. 26, 2019

(54) CROSS-FUNCTIONAL ANALYTICS TOOL FOR INTEGRATING WEB ANALYTICS DATA AND CUSTOMER RELATIONSHIP MANAGEMENT DATA

(71) Applicant: Stoke Analytics, LLC, Provo, UT (US)

(72) Inventors: Sam FONOIMOANA, Orem, UT (US); Laura B. LOHNER, Provo, UT (US)

(21) Appl. No.: 16/353,958

(22) Filed: Mar. 14, 2019

Related U.S. Application Data
(60) Provisional application No. 62/648,366, filed on Mar. 26, 2018.
(60) Provisional application No. 62/793,280, filed on Jan. 16, 2019.

(51) Int. Cl. G06Q 30/00; H04L 29/08

(52) U.S. Cl. CPC G06Q 30/01; H04L 67/306; H04L 67/22

(57) ABSTRACT

The present disclosure relates to systems, methods, and computer-readable media for integrating web activity data collected via an analytics system and customer relationship management (CRM) activity data collected via a CRM system. In particular, systems disclosed herein include a cross-platform integration system that facilitates associating CRM activity data with a unique visitor identifier that may be used to associated CRM activity data for a corresponding customer with web activity data for one or multiple customer devices of the same customer. The systems disclosed herein automate the process of associating the unique visitor identifier with associated CRM activity data. In addition, systems disclosed herein facilitate combining the associated data into an integrated report.

### CROSS-REFERENCE TO RELATED APPLICATIONS

This application claims priority to U.S. Provisional Patent Application No. 62/648,366, filed on Mar. 26, 2018, and titled “CROSS-FUNCTIONAL ANALYTICS TOOL THAT INTEGRATES WEB ANALYTICS DATA AND CUSTOMER RELATIONSHIP MANAGEMENT DATA,” which is incorporated herein in its entirety. This application also claims priority to U.S. Provisional Patent Application No. 62/793,280, filed on Jan. 16, 2019, and titled “CROSS-FUNCTIONAL ANALYTICS TOOL FOR INTEGRATING WEB ANALYTICS DATA AND CUSTOMER RELATIONSHIP MANAGEMENT DATA,” which is incorporated herein in its entirety.

### BACKGROUND

Customers and potential customers interface with businesses, product providers, and other entities in a variety of ways. Indeed, as communication technology advances, businesses, product providers, and other entities are utilizing a greater number of products and services to collect data about customers and potential customers to better understand ways in which a business is successfully engaging and influencing contacts and ways in which the business may improve. For example, many businesses employ customer relationship management (CRM) tools and services to track various interactions and collect customer data representative of the interactions between an individual and one or more business entities. As another example, businesses often employ web analytics tools and services to track online activity data by any number of individuals in connection with a website or collection of websites associated with the business.

While CRM and web analytics programs and services provide valuable tools for collecting data about customers and various individuals, as the number of observable activities increases, and as more and more interactions with businesses and other entities occur over the Internet (e.g., via Internet browsers, web applications, mobile apps, etc.), conventional systems often fail to effectively collect and associate related data collected using different tools and services. Indeed, when using multiple services that are provided by independent entities using different platforms or data formats, many entities experience frustration or expend considerable cost and manpower in attempting to identify relationships or trends between datasets generated by independent services. As a result, businesses, marketers, and other entities often fail to effectively understand or utilize data collected about customers and potential customers.

### BRIEF DESCRIPTION OF THE DRAWINGS

FIG. 1 illustrates an example environment including a cross-platform data integration system for integrating web analytics data and customer relationship management (CRM) data in accordance with one or more embodiments.

FIG. 2A illustrates an example implementation for integrating data from a web analytics platform with data from a CRM platform in accordance with one or more embodiments;

FIG. 2B illustrates another implementation for integrating data from a web analytics platform with data from a CRM platform in accordance with one or more embodiments;

FIG. 3 illustrates an example implementation in which a cross-platform data integration system generates an integrated data report in accordance with one or more embodiments;

FIG. 4A illustrates an example implementation in which an analytics system utilizes an integrated data report to generate one or more comprehensive data reports in accordance with one or more embodiments;

FIGS. 4B-4E illustrate example presentations of integrated data reports and comprehensive data reports in accordance with one or more embodiments;

FIG. 5A illustrates a flow diagram of interactions between computing devices of an environment including a cross-platform data integration system in accordance with one or more embodiments;

FIG. 5B illustrates another flow diagram of interactions between computing devices of an environment including a cross-platform data integration system in accordance with one or more embodiments;

FIG. 6 illustrates an example method for deploying and utilizing a cross-platform data integration system in accordance with one or more embodiments;

FIG. 7 illustrates another example method for deploying and utilizing a cross-platform data integration system in accordance with one or more embodiments;

FIG. 8 illustrates certain components that may be included within a computer system.

### DETAILED DESCRIPTION

The present disclosure generally relates to a cross-platform data integration system implemented in connection with an analytics system and customer relationship management (CRM) system. In particular, as will be discussed in further detail herein, a cross-platform data integration system (or simply “integration system”) can automate tagging of customer activity data (e.g., CRM data) tracked by a CRM system with a visitor identifier that enables the integration system to associate corresponding web activity tracked by an analytics system with corresponding CRM data for a particular customer. Indeed, even where an analytics system and CRM system are implemented on different server devices and operated by different entities (e.g., different companies), the integration system in accordance with one or more implementations described herein can nonetheless associate specific instances of web activity with instances of CRM activity (e.g., offline activity) to generate an integrated report that more accurately reflects the customer journey(s) of individuals associated with a particular product, business, or other entity.

As used herein, web activity data, web interaction data, or web analytics data (hereinafter “analytics data”) can refer interchangeably to any data collected by an analytics system with respect to actions performed using a customer device (e.g., a computing device). An analytics system may utilize cookies, tracking pixels, tags, or other web analytics tools embedded within a Hypertext Markup Language (HTML) code or other web document for a web page or website to track activity of computing devices interacting with a web page or other online entity. Indeed, web analytic tools may ingest data using tags and other tools and process incoming web activity into a data format that can be visualized and analyzed in a respective toolset or generated report. In one or more embodiments, web activity or analytics data refer interchangeably to any data tracked using one or more tools or digital objects created by or deployed by an analytics system.

As used herein, customer activity data or CRM data may refer interchangeably to any data associated with actions by an individual or user of a customer device with respect to a product, business, merchant, or other entity tracked by and/or otherwise maintained by a CRM system. For instance, a CRM system can track or otherwise collect data about a customer's history with a company to improve business relationships with the customer, identify trends regarding customer retention, or drive sales growth. CRM systems may compile and utilize data from a range of different sources including, by way of example, a company website, telephone, email, live chat, marketing materials, and social media. In one or more embodiments described herein, CRM data refers to offline activity (e.g., in-person activity) by individuals with respect to a business or merchant (or other entity acting as a client for the CRM system). In addition, CRM data may refer to online activity including, for example, social media activity, blog posts, instant messages, email interactions, or activity across a variety of websites (e.g., other than one or more websites tracked using the analytics system).

Implementations of the present disclosure provide benefits and/or solve one or more problems associated with collecting and integrating data from different platforms (e.g., independently owned and operated server devices). For example, as will be discussed in further detail below, an integration system can deploy a container including instructions for tagging customer activities (e.g., a collection of tracked customer activities tracked and maintained by a CRM system) with a unique visitor identifier (e.g., a random number or other identifier assigned by an analytics system). The integration system can utilize the unique visitor identifier to associate tracked web activity data (e.g., activity tracked by the analytics system) with customer activity data (e.g., online and/or offline activity tracked by the CRM system) to map individual customer journeys including a combination of both analytics data and CRM data. As used herein, a “unique visitor identifier” or “visitor identifier” refer interchangeably to an identifier assigned to a customer device by the analytics system.

By tagging customer activity data in this way, the integration system facilitates integrating data generated by different platforms and having different formats and/or customer identifiers in a way that does not add significant processing overhead or limit functionality of the independent data tracking platforms. Indeed, by tagging the activities with a unique visitor identifier, the integration system can associate both online and offline activity corresponding to respective customer journeys without requiring that the independent analytics system(s) and/or CRM system(s) share proprietary information and/or compromise security or privacy of customers and clients. Moreover, by integrating functionality of the two different systems, the integration system strengthens the overall utility of the respective analysis platforms in providing more comprehensive data reports to clients.

In addition, by deploying the container on a website (or series of websites) and providing instructions within the deployed container, the integration system additionally facilitates automation of associating different types of data associated with respective different data platforms. For example, because the instructions included within the container cause a web server hosting a website to access a CRM system (e.g., via an application programming interface (API) of the CRM) and tag customer activity data for a corresponding customer (or potential customer), the integration system causes the customer activity data (e.g., a lead file including the lead activities) to include a permanent association between a unique visitor identifier assigned by an analytics system and subsequent customer activity data tracked by the CRM system in such a way that enables the integration system, whether implemented on an individual client device or on the analytics system, to easily compile corresponding data for individuals connected to both web activity and corresponding customer activity.

In one or more embodiments described herein, customer activity data or CRM data is referred to as a “lead file” to indicate one or more digital files including instances of customer or potential customer activity tracked by a CRM system. For example, a lead file may refer to a digital file or collection of multiple files including data associated with a corresponding customer tracked by or otherwise managed by the CRM system. Nevertheless, while one or more examples discussed herein will refer specifically to one or more lead files corresponding to respective customers, it will be understood that a lead file may refer to multiple files or any data content item including tracked customer activity data associated with a corresponding individual.

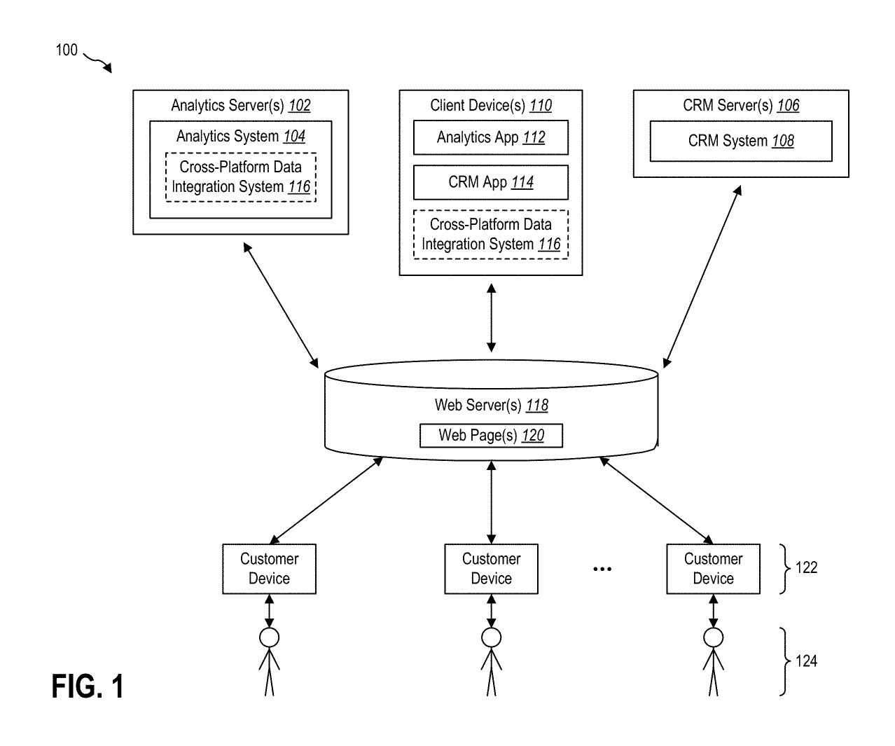

Additional detail will now be provided regarding the integration system in relation to illustrative figures portraying example implementations. For example, FIG. 1 illustrates an example environment on which a cross-platform data integration system 116 (or simply “integration system 116”) can be implemented. As shown in FIG. 1, the environment 100 includes one or more analytics server(s) 102 having an analytics system 104 implemented thereon. The integration system 116 (or portion of the integration system 116) may be implemented within the analytics system 104.

The environment 100 also includes one or more CRM server(s) 106 having a CRM system 108 implemented thereon. The analytics server(s) 102 and CRM server(s) 106 may include independent networks of one or multiple server devices. In addition, the analytics server(s) 102 and CRM server(s) 106 may be owned, operated by, or otherwise managed by independent entities. Each of the analytics system 104 and CRM system 108 may facilitate communication with a client device(s) 110 (e.g., over a network, such as the Internet).

As shown in FIG. 1, the environment 100 additionally includes one or more client device(s) 110 including an analytics application 112, CRM application 114, and integration system 116. The analytics application 112 may include a software application associated with the analytics system 104 (e.g., a software product, suite of multiple software products) that enable the client device(s) 110 to communicate with or otherwise access services or data provided by the analytics system 104. Similarly, the CRM application 114 may include a software application associated with the CRM system 108 that enables the client device(s) 110 to communicate with or otherwise access services or data provided by the CRM system 108.

As further shown, the client device(s) 110 can include the integration system 116 (or portion of the integration system 116) implemented thereon. As indicated by the dotted boxes, the integration system 116 may be implemented entirely on the client device(s) 110 or on the analytics system 104. In one or more embodiments, the integration system 116 is implemented cooperatively on the analytics system 104 and the client device(s) 110. For example, as will be discussed below, the analytics system 104 may implement a portion of the integration system 116 for deploying a container on a web page while the client device(s) 110 may implement a portion of the integration system 116 for integrating data from two independent platforms (e.g., the analytics system 104 and the CRM system 108).

As illustrated in FIG. 1, the environment 100 additionally includes one or more web server(s) 118 in communication with the analytics server(s) 102, client device(s) 110, and CRM server(s) 106. The web server(s) 118 may host or otherwise provide access to any number of web page(s) 120 hosted thereon (e.g., a collection of associated websites or web pages). For example, a web server 118 may host a website including one or more web pages by providing access to one or more Hypertext Markup Language (HTML) document or other web document including web content thereon that enables customer devices 122 operated by associated users 124 to view, download, save, modify, or otherwise interact with the web content via graphical user interfaces of the customer devices 122.

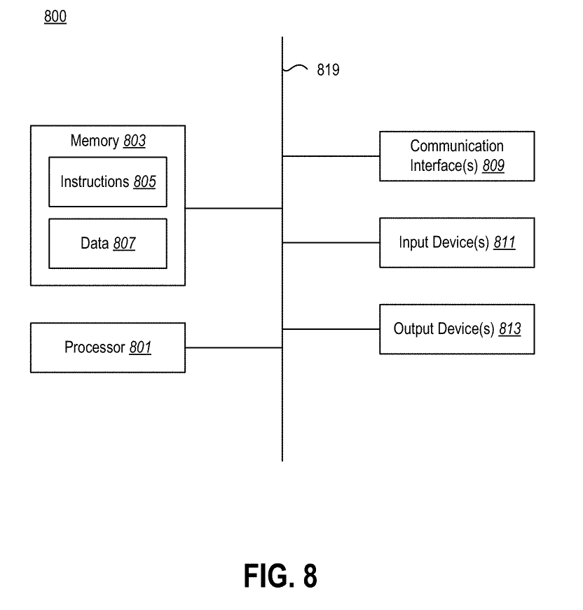

Each of the devices of the environment 100 may refer to various types of electronic devices. For example, the analytics server(s) 102, CRM server(s) 106 and web server(s) 118 may include server devices. These devices may be implemented as part of respective cloud computing networks or other distributed networks of electronic devices. In one or more embodiments, the client device 110 is a server device. In some implementations, the components 112-116 of the client device(s) 110 are implemented within the web server(s) 118 (or vice versa). Moreover, in one or more embodiments, the client device(s) 110 is associated with, administrates, or otherwise manages the web server 118. For example, the client device 110 may refer to an admin device associated with administering, hosting, or otherwise managing web sites hosted by the web server(s) 118. In addition, each of these devices may include similar features and functionality as other computing devices, such as the computing device described below in connection with FIG. 8.

Moreover, each of the customer devices may refer to various types of computing devices including, by way of example, mobile devices, desktop computers, or other types of computing devices. In addition, one or more of the users 124 may be associated with multiple client devices of the same or different type. For example, a customer may utilize a mobile device and a desktop to access the same website. Moreover, each of the customer devices may include different web browsers or applications thereon. For example, a customer device may include two different web browsers. Each of the customer devices 122 may include similar features and functionality as the computing device described below in connection with FIG. 8.

In addition, each of the devices shown in the environment 100 may communicate over one or multiple networks. For example, the devices shown in FIG. 1 may communicate using one or multiple types of communication protocols or technologies for transmitting data. For instance, in one or more embodiments, the devices shown in FIG. 1 may interact or otherwise communicate over the Internet or another data link that enables transport of electronic data between respective devices.

The number and arrangement of devices shown in FIG. 1 are provided by way of example. Other embodiments may include additional or fewer server devices and customer devices. For example, one or multiple users may be associated with a corresponding customer device and/or a single user may be associated with any number of customer devices. In addition, one or more users may utilize one or multiple browsers on a respective customer device, which the analytics system 104 may associate with two distinct unique visitor identifiers. Moreover, as mentioned above, in one or more embodiments, the client device 110 and web server 118 may be implemented within a single device or network of devices. In addition, as will be described in more detail herein, different components of the integration system 116 may be implemented on different systems or devices.

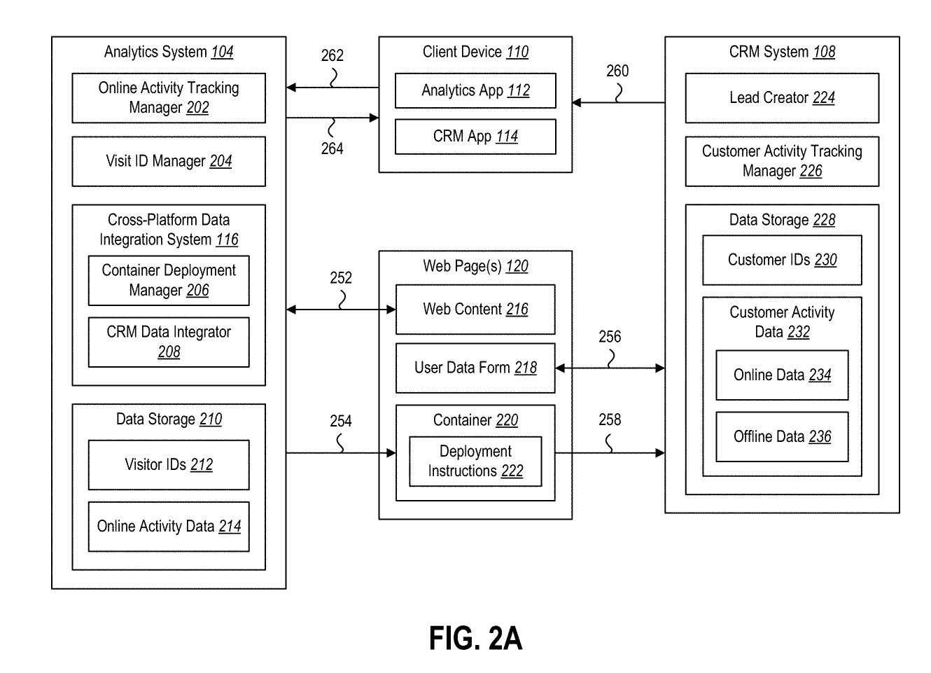

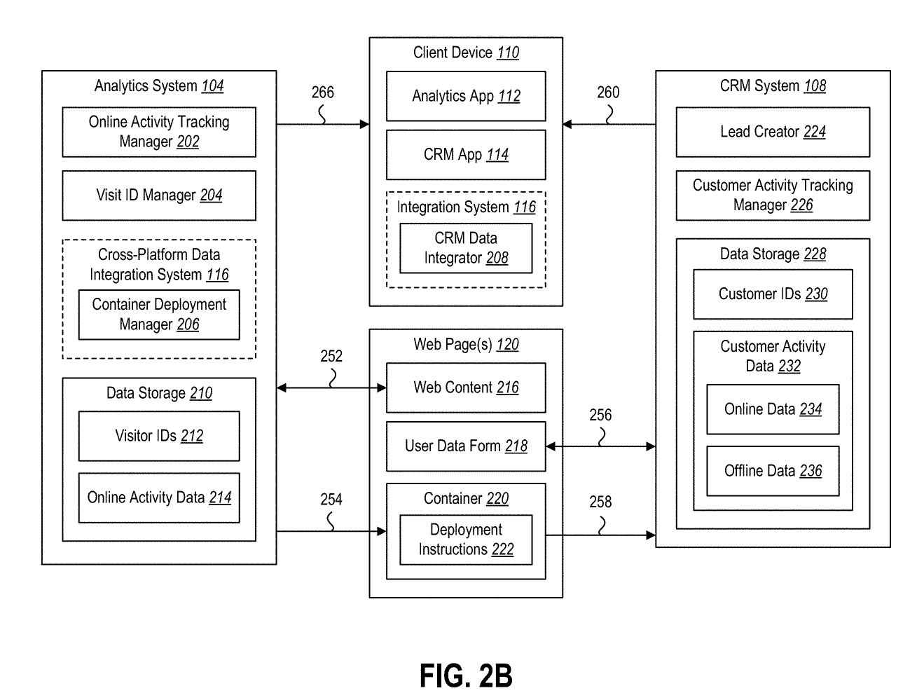

Additional detail in connection with the respective systems and devices illustrated in FIG. 1 will now be described in connection with FIGS. 2A-2B. In particular, the analytics system 104 may include an online activity tracking manager 202 and visitor ID manager 204. The analytics system 104 may additionally include the integration system 116 having a container deployment manager 206 and CRM data integrator 208 (e.g., a data stitching application) implemented thereon. The analytics system 104 may further include a data storage 210 including visitor IDs 212 and online activity data 214 (e.g., web activity data). As further shown, a web server (e.g., the web server(s) 118) can provide one or more web pages 120 including web content 216, a user data form 218, and a container 220 having deployment instructions 222 (or tagging instructions) included therein. The web page(s) 120 may include an HTML document or other web document that enables a presentation of web content 216 via a graphical user interface of a customer device. In addition, while FIG. 2A illustrates an example in which a web server provides one or more web pages 120, the web server 118 may host any number of web pages corresponding to one or multiple independent or related websites.

As shown in FIG. 2A, the analytics system 104 can perform an act 252 of tracking web activity of customer devices with respect to web content 216 on the web page 120. For example, the online activity tracking manager 202 can deploy cookies, tracking pixels, or other web activity tracking tools on a web page 120 that enable the analytics system 104 to observe certain types of activity performed by a user of a customer device that obtains access to the web page 120. For instance, the online activity tracking manager 202 may provide a tracking cookie or other tracking tool to a customer device that the customer device provides when requesting web content. Alternatively, the online activity tracking manager 202 may cause an analytics tool deployed on the web server to provide a tracking cookie or other tracking tool to the customer device.

Indeed, the analytics system 104 and/or web server 118 may track web activity using any number of web activity tracking tools capable of tracking various types of web activity. For example, the online activity tracking manager 202 can track activities such as instances of website visits, clicks on specific links, pages opened, duration of time viewing a page or document, specific interactions (e.g., highlights, editing, etc.) with respect to corresponding web content, or other trackable web activities performed using a customer device.

In tracking web activity for a customer device, the integration system 116 can additionally associate a unique visitor identifier with a customer device. For example, the visitor ID manager 204 may assign a customer device a unique visitor ID (e.g., a random number or string of text) that may be used to track any number of web activities performed by a customer device (while using a specific web browser) with respect to the website. In one or more embodiments, the visitor ID manager 204 assigns the visitor ID by providing the unique visitor ID via a download to a customer device to store within an application or file that may be accessed or retrieved by the visitor ID manager 204 at each subsequent visit to the website (or web page 120). In this way, the online activity tracking manager 202 can track online activity over a period of time extending multiple visits to the web page.

It will be understood that the visitor ID manager 204 may assign a unique visitor ID on a first visit to a web page by a customer device using a corresponding browser application. Indeed, the visitor ID manager 204 may assign multiple unique visitor IDs to the same customer device where that customer device visits the website using different browser applications. Thus, the online activity tracking manager may track and map or index web activity based on activity by a specific customer device using a corresponding web browser application.

As shown in FIG. 2A, the integration system 116 may include a container deployment manager 206. In one or more embodiments, the container deployment manager 206 performs an act 254 of deploying a container 220 via the web page 120. For example, the container deployment manager 206 may embed JavaScript or other digital code within the container 220 added to the HTML document in response to the client device 110 or administrator of the web page(s) 120 using an analytics application 112 to sign up or register the website with the analytics system 104. The container 220 may include any type of web container or other web component configured to embed within the web page (or within multiple web pages) and implement a variety of instructions (e.g., deployment instructions 222) included within.

Indeed, as shown in FIG. 2A, the container deployment manager 206 may provide deployment instructions 222 within the container 220. The container deployment manager 206 may provide the deployment instructions 222 at the same time as deployment of the container 220. Alternatively, in one or more embodiments, the instructions 222 are added after deployment of the container 220 on the web page 120. In one or more embodiments, the instructions 222 are provided via a development tool provided by the analytics system 104. Alternatively, a user of the client device or other computing device having administrative access to the web page 120 may add the deployment instructions 222 within the container 220.

In one or more embodiments, the deployment instructions 222 include JavaScript code or other digital data including instructions embedded within the container 220. In particular, the deployment instructions 222 may include instructions that facilitate tagging customer activity data with the unique visitor identifier associated with a customer device. The deployment instructions 222 may include code configured to cause the web server to perform one or more actions prior to and/or in response to detecting a trigger event. The deployment instructions 222 may include code configured to cause the web server to monitor data entered using the user data form 218 including customer information such as an email, name, login data or other information that may be used to identify the individual associated with the information entered into the user data form 218.

In addition to code for generally collecting information, the deployment instructions 222 may further include code to facilitate tagging customer activity data with information (e.g., a unique visitor identifier) associated with a customer device and/or individual associated with the customer device. For example, the instructions 222 may include code that causes the web server 118 to detect submission of the user data form 218 (e.g., detect that a user has clicked a “submit” icon) and, in response, perform a series of steps. For instance, in accordance with the deployment instructions 222, the web server 118 may identify a unique visitor identifier associated with the customer device assigned by the analytics system 104. In addition, the web server 118 may identify a customer identifier (e.g., an email, a name, a login) associated with the customer and/or individual corresponding to the data entered into the user data form 218 and submitted to the CRM system 108. Upon identifying this information, the web server 118 may additionally tag customer activity data (e.g., a lead file) generated and maintained by the CRM system 108. Tagging the customer activity data with the visitor identifier will be discussed in further detail below.

As mentioned above, the integration system 116 additionally includes the CRM data integrator 208 for integrating CRM data and web activity data. Additional detail in connection with integrating web activity data and customer activity data stored and maintained by the respective analytics and CRM platforms will be discussed in further detail below.

As mentioned above, the data storage 210 includes a collection of visitor IDs 212 and online activity data 214. The visitor IDs 212 may include any number of unique visitor identifiers that have been assigned to corresponding customer devices. While FIG. 2A shows an example in which the visitor IDs are stored on the data storage 210 of the analytics system 104, in one or more embodiments, the assigned visitor IDs may be distributed between any number of customer devices.

The data storage 210 additionally includes online activity data 214. The online activity data 214 may include any web activity data associated with actions by individuals using customer devices upon visiting one or more web pages (e.g., web page(s) 120). Examples of online activity data 214 include identified clicks, selections of documents, photos, videos, files, or other content provided or linked via a web page. Online activity data may also include metrics such as a duration of time that a given photo, video, file, or other content was viewed by a user, scrolling data, and download data (e.g., whether a file was downloaded). Indeed, online activity data 214 may refer to any data that the analytics system 104 is configured to collect with regard to interactions by a customer device with respect to web content provided via one or more web pages.

As further shown in FIG. 2A, the environment includes a CRM system 108. The CRM system 108 includes a lead creator 224, a customer activity tracking manager 226, and a data storage 228. The data storage 228 includes customer IDs 230 and customer activity data 232, which may include online data 234 and offline data 236. In one or more embodiments, the customer activity data 232 only includes offline data.

As shown in FIG. 2A, the CRM system 108 may perform an act 256 of collecting data from a user data form 218 provided via the web page 120. For example, the web page 120 may include a user data form 218 (e.g., provided by the web server 118) including fields of information that a customer (e.g., user of a customer device) may fill out to provide personal data associated with a customer to the CRM system 108. For instance, a customer may provide personal information including a name, email, address, login and password, or other combination of personal data for the CRM system 108 to use in generating a lead file or lead report corresponding to an individual associated with the data.

In particular, in response to a user filling out the user data form 218 and clicking “submit” (or other input provided in conjunction with the user data form 218), the web server 118 may provide the user information to the CRM system 108 and the lead creator 224 may trigger creation of a lead file including a file or report that includes a customer identifier (e.g., assigned by the CRM system 108) for the customer who filled out the user data form 218. The lead creator 224 may assign a unique customer ID or simply use the email or other unique identifier provided by the customer. The lead creator 224 may generate any number of lead files corresponding to any number of users who fill out or otherwise provide data to the CRM system 108 via the user data form 218 on the web page 120.

As shown in FIG. 2A, the CRM system 108 additionally includes a customer activity tracking manager 226 that tracks, collects, or otherwise manages customer activity associated with the individual that filled out the user data form 218. For example, the customer activity tracking manager 226 can collect or manage customer activity including purchases, in-person visits, phone calls, or any other interactions or touchpoints (e.g., physical or online) with an entity (e.g., a business) associated with the web page 120. In one or more embodiments, the customer activity tracking manager 226 specifically observes and tracks offline activity (e.g., human to human or business to business interactions). In addition, the customer activity tracking manager 226 can track online activity where the customer subsequently provides information that enables the customer activity tracking manager 226 to associate the corresponding online activity with a customer identifier associated with the customer or potential customer (e.g., where the customer logs into a website, social media platform, or otherwise provides personal information that may be mapped to customer information previously provided to the CRM system 108).

In addition to collecting customer information and tracking customer activity, the CRM system 108 can additionally receive a unique visitor identifier in accordance with the deployment instructions 222 within the container 220. For example, as discussed above, the deployment instructions 222 may include code or other data structure that causes the web server 118 to collect data associated with a customer (e.g., identify a visitor identifier corresponding to a customer device, identify a customer identifier (e.g., an email, login, name, address)). In addition, the deployment instructions 222 can cause the web server 118 to perform an act 258 of tagging a lead file created by the lead creator 224 with a visitor identifier or other information that enables the integration system 116 to associate web activity data collected by the analytics system 104 and customer data tracked by the CRM system 108. In addition, by implementing the instructions 222 within the container 220 in accordance with one or more embodiments described herein, the web server 118 automatically tags the lead file (or other digital item including customer activity data for a corresponding customer) with the visitor identifier without further input or requiring that an individual manually associate data from the different platforms.

As an illustrative example, in response to a user selecting “submit” and causing the web server 118 to provide the user data form 218 to the CRM system 108 (or other detectable event to trigger tagging a lead file), the web server 118 may access an API of the CRM system 108 accessible to the web server 118 that enables the web server to access a collection of lead files generated and maintained by the CRM system 108. Upon accessing the collection of lead files, the web server 118 may determine which of the lead files corresponding to a customer identifier that matches customer information (e.g., an email or other customer information) provided within the user data form 218. Based on identifying a lead file including matching customer information, the web server may tag the unique visitor identifier to the lead file in a variety of ways (e.g., adding the visitor identifier to a document, adding metadata to a file). At this point, the customer data within a particular lead file may be associated with a corresponding visitor identifier previously assigned to a customer device. Going forward, the CRM system 108 may continue to track customer activity to include within the lead file tagged with the unique visitor identifier while the analytics system 104 continues to track and compile web activity by a customer device associated with the unique visitor identifier.

In addition to associating a lead file with a corresponding visitor identifier in response to an initial event where a customer fills out a form and clicks submit, the instructions 222 may further include data that causes the web server 118 to associate one or more multiple visitor identifiers with the same lead file in response to other triggering events. For example, where a lead file is tagged with a first visitor identifier based on a customer initially submitting a user data form 218, the integration system 116 can additionally tag the same lead file with one or more additional visitor identifiers in response to other events associated with web activity performed using a different device or browser by the same individual.

For example, where a customer owns two different devices (e.g., a desktop and mobile device), the customer may fill out the web form on a first visit to a website (triggering tagging of a lead file) while using a first customer device. On a subsequent visit using a second customer device, however, the customer may instead provide login information rather than fill out a web form again. In this instance, the analytics system 104 may assign a second visitor identifier corresponding to the second customer device or browser while the customer identifier (e.g., email address) provided by the user in logging into the website may be associated with a previously tagged visitor identifier. In this case, execution of the instructions 222 may trigger the web server 118 to add the second unique visitor identifier to the lead file that already includes a first unique visitor identifier, thereby associating multiple unique visitor identifiers to the same set of customer activity data (e.g., the same lead file). In accordance with one or more embodiments described herein, the integration system 116 can therefore associate analytics data associated with different visitor identifiers to the same customer activity data in generating an integrated report or comprehensive report representative of the web activity and associated customer activity.

As shown in FIG. 2A, the CRM system 108 includes a data storage 228 including customer identifiers 230 and customer activity data 232. The customer identifiers 230 may include any number of identifiers or information corresponding to customers or potential customers of a client, merchant, or other entity for which the CRM system 108 is tracking customer activities. The customer identifiers 230 may correspond to information provided from the user data form 218. For example, the customer identifiers 230 may include (or be associated with) emails, names, logins, or other types of information that the CRM system 108 uses to associate activity corresponding to a respective lead.

The data storage 228 may additionally include customer activity data 232, which may include any information associated with customer activities tracked and managed or stored by the customer activity tracking manager 226. The customer activity data 232 may include online data 234 including web activity tracked across one or more web pages or Internet platforms. In addition, the customer activity data 232 may include offline data 236 including offline activity performed by a customer associated with a corresponding customer identifier. This may include instances and content of phone calls, in-person visits to stores or business locations, or any other direct interactions or points of contact between a business or other entity and the customer(s). The customer identifiers 230 and associated customer activity data 232 may be stored within a corresponding lead file mapped to a particular customer.

At any point, the CRM system 108 can perform an act 260 of providing a lead file (or collection of lead files) to the client device 110. For example, in response to a request for customer information, the CRM system 108 may provide a lead file or multiple lead files including tracked customer activities and corresponding customer identifiers. Furthermore, the lead file may include the unique visitor identifier tagged to the lead file by the web server in accordance with the deployment instructions 222 included within the container 220 on the web page 120.

Upon receiving the lead file(s) and associated customer activity information, the client device 110 may perform an act 262 of providing the lead files and associated information (e.g., customer identifiers, customer activity data, and tagged visitor identifier) to the analytics system 104. In particular, the analytics system 104 can receive the lead files and utilize the integration system 116 (e.g., the CRM data integrator 208) thereon to generate an integrated report that includes both web activity tracked by the analytics system 104 and the customer activity tracked by the CRM system 108. In particular, the integration system 116 can combine the data based on the unique visitor identifier associated with the online activity data and the unique visitor identifier associated with the CRM data tagged to the lead file(s).

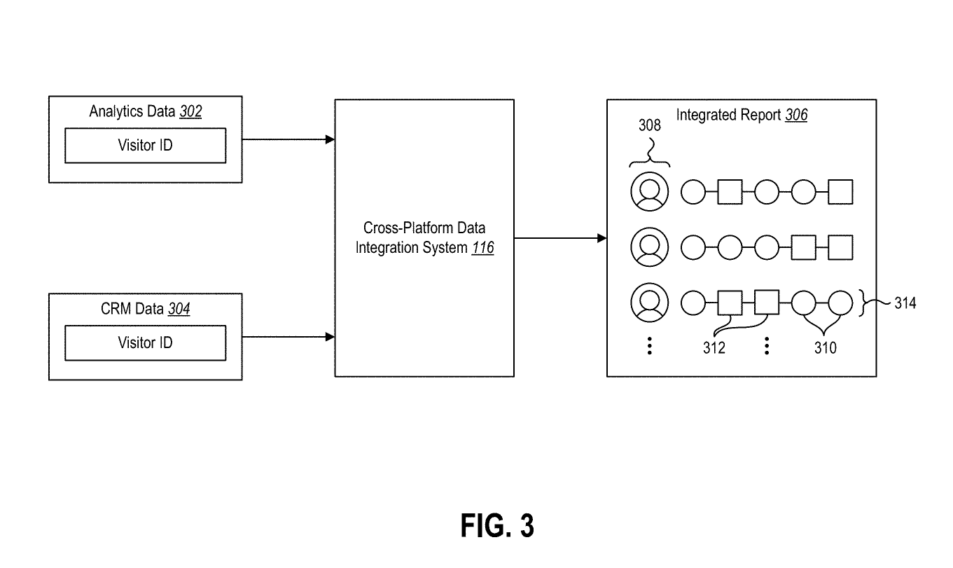

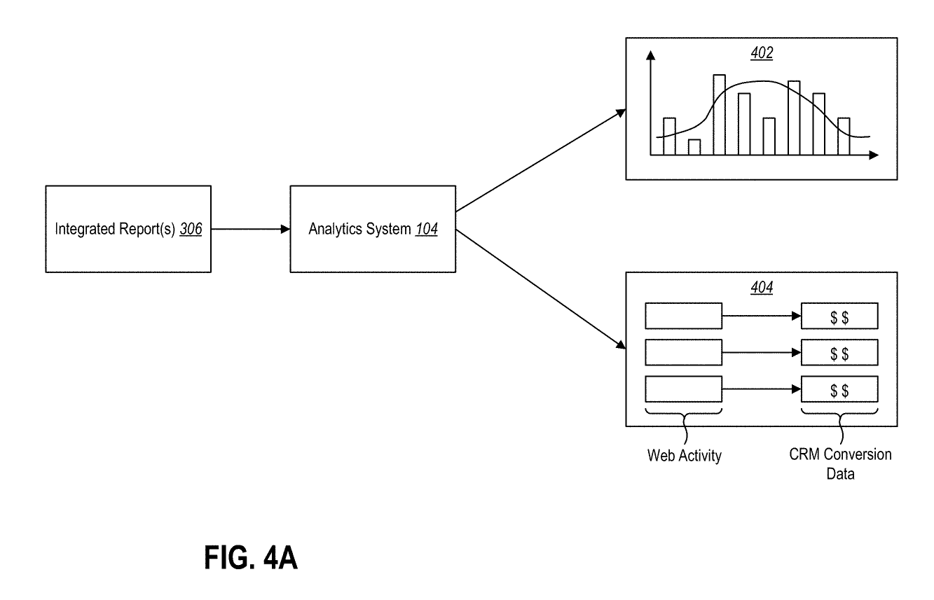

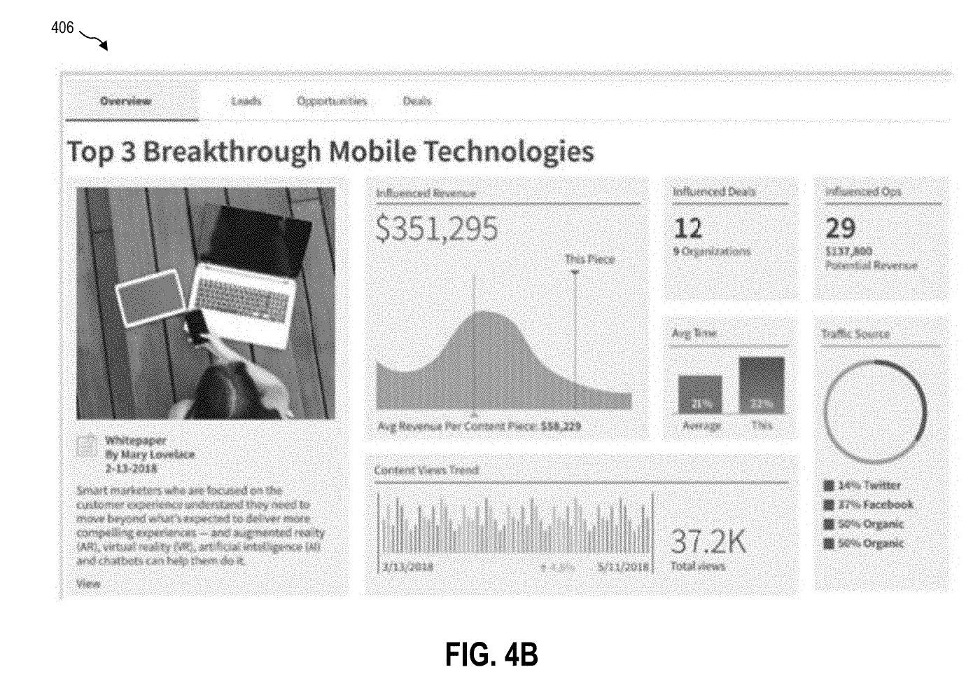

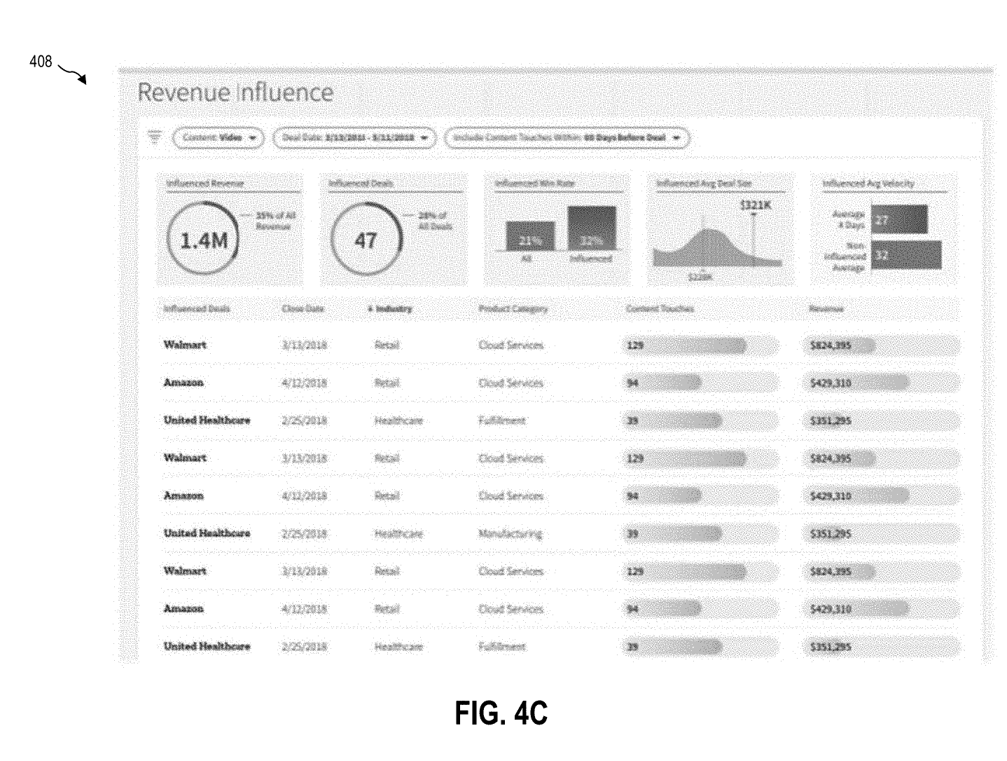

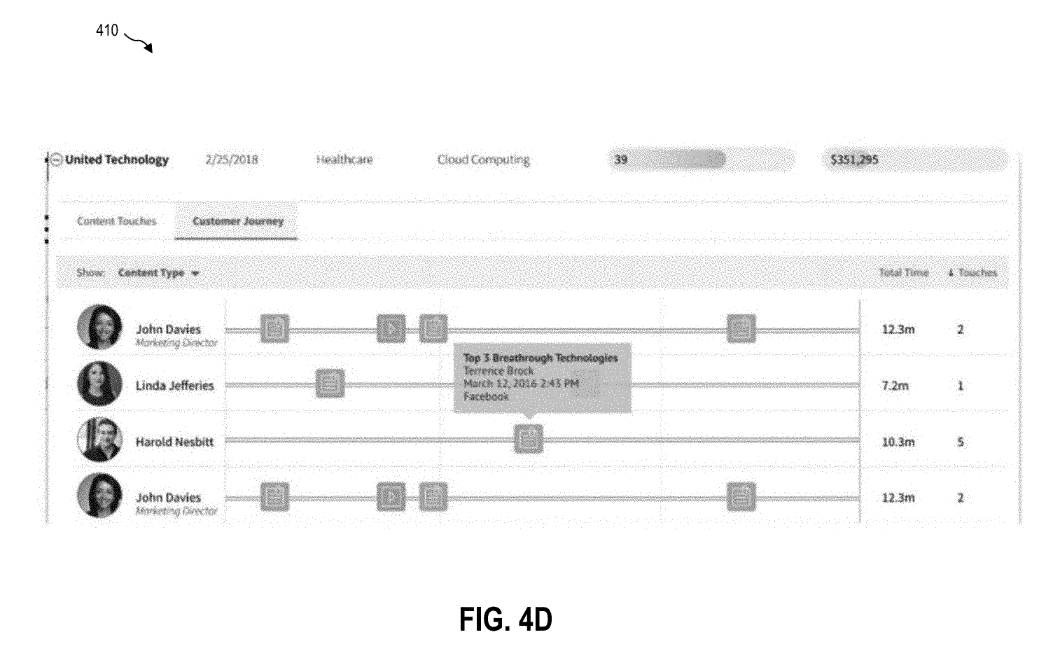

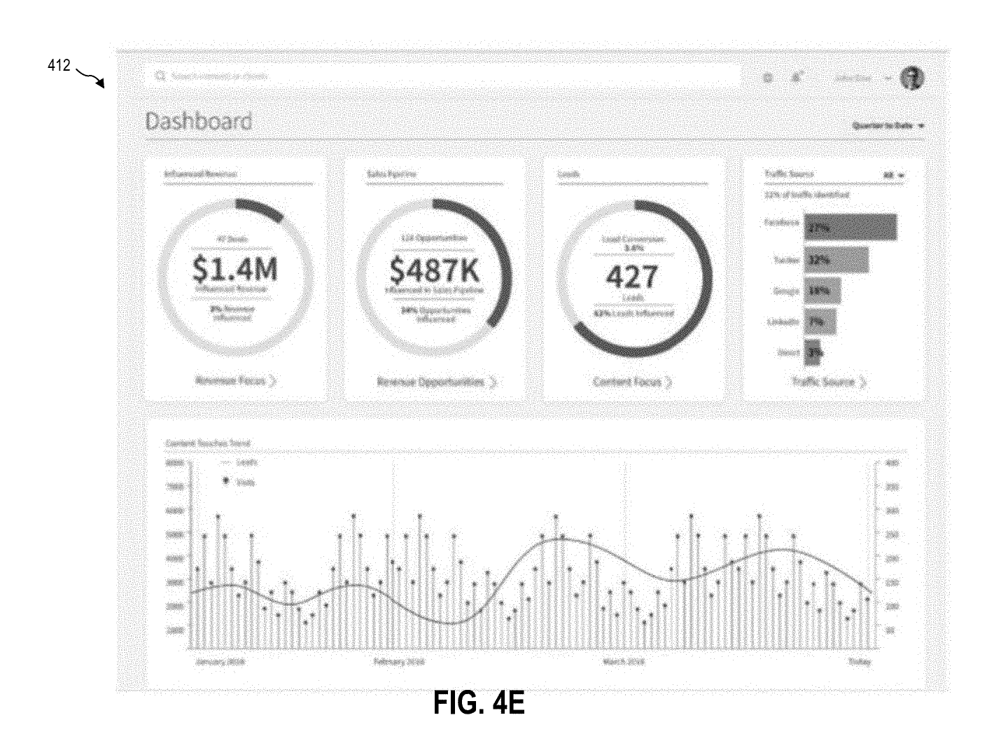

The integration system 116 can associate the data collected by the respective platforms in a variety of ways. For example, the integration system 116 can identify CRM data tagged with a unique visitor identifier and identify tracked web activity data associated with the same unique visitor identifier. The integration system 116 can additionally sequence the data based on a timestamp or date identifier associated with the tracked action of the corresponding customer or customer device. In one or more embodiments, the integration system 116 combines the data into an integrated report that provides a representation of a customer journey including both types of data (e.g., CRM data, analytics data). The integration system 116 can generate an integrated report for any number of individuals. In addition, or as an alternative, the integration system 116 can generate a comprehensive report including trends or other analysis related to multiple individuals and customer devices. Additional detail in connection with generating and presenting both integrated and comprehensive reports will be discussed in connection with FIGS. 3 and 4.

Upon integrating the data (e.g., generating an integrated report or other comprehensive report including a combination of both analytics data and CRM data), the analytics system 104 can additionally perform an act 264 of providing the integrated report to the client device 110. In one or more embodiments, the integration system 116 provides a file or collection of files to the client device 110 by providing the file(s) via a download performed by the client device 110. Alternatively, in one or more embodiments, the integration system 116 maintains the integrated data on the analytics system 104 and provides access to the integrated data including any number of reports via a graphical user interface on the client device 110. For example, the client device 110 may login to an account with the analytics system 104 and navigate any number of reports including the integrated report generated and presented by the integration system 116.

FIG. 2B illustrates another example configuration of components in accordance with one or more embodiments described herein. In particular, the configuration illustrated in FIG. 2B similarly includes an analytics system 104, CRM system 108, client device(s) 110 and web page(s) 120 including similar features and functionality as discussed above in connection with FIG. 2A. In contrast to FIG. 2A, however, the integration system 116 may be implemented cooperatively between the analytics system 104 and client device(s) 110.

For example, in contrast to the configuration of components shown in FIG. 2A, the integration system 116 illustrated in FIG. 2B is implemented at least partially on both the analytics system 104 and the client device 110. In particular, the container deployment manager 206 is implemented on the analytics system 104 while the CRM data integrator 208 is implemented on the client device 110. As discussed above, the container deployment manager 206 can perform an act 254 of deploying or otherwise implementing the container 220 on the web page 120. In one or more embodiments, the container deployment manager 206 additionally provides the instructions 222 within the container 220. Alternatively, in one or more embodiments, the client device 110 provides the instructions 222 within the container.

Similar to FIG. 2A, the client device 110 can receive the CRM data from the CRM system 108. In one or more embodiments, rather than providing the CRM data to the analytics system 104, the integration system 116 can cause the client device 110 to perform an act 266 of receiving the analytics data from the analytics system 104. The analytics system 104 may provide analytics data including an analytics report based on the tracked web activity tracked by the analytics system 104. The analytics data may additionally include the tracked data and corresponding visitor identifiers (or other form of the data) to the client device 110 to enable the CRM data integrator 208 to integrate the analytics data and the CRM data. The CRM data integrator 208 on the client device 110 can associate, combine, and/or stitch the CRM data and analytics data together similar to one or more embodiments discussed above.

Additional detail is now provided in connection with generating an integrated report based on the analytics data (e.g., web activity data tracked by and maintained by the analytics system 104) and CRM data (e.g., customer activity data tracked by and maintained by the CRM system 108). In particular, the cross-platform data integration system 116 can receive analytics data 302 including any data tracked by and maintained by the analytics system 104. The integration system 116 can additionally receive CRM data 304 including any data tracked by and maintained by the CRM system 108. For example, the CRM data 304 may include information from a collection of lead files associated with corresponding customers.

As shown in FIG. 3, each of the analytics data 302 and CRM data 304 may include associated visitor identifiers to indicate a corresponding customer device and/or individual associated with the data. Indeed, the analytics data 302 may include the unique visitor identifier assigned to each instance of web activity by the analytics system 104. In addition, the CRM data 304 may include unique visitor identifiers tagged to respective lead files and associated customer activity data in accordance with the instructions 222 within the container 220 deployed to the web page 120.

Based on the analytics data 302, CRM data 304, and corresponding visitor identifiers, the integration system 116 can generate an integrated report 306 including a representation of both analytics data 302 and CRM data 304 associated with corresponding individuals and/or devices. For example, as shown in FIG. 3, the integrated report can include an indication of customers 308 associated with corresponding unique visitor identifiers and a collection of individual customer journeys 314 including instances of tracked web activity 310 (e.g., instances of activity from the analytics data 302) and instances of tracked customer activity 312 (e.g., instances of activity from the CRM data 304).

In addition to providing indications of the respective instances of web activity 310 and customer activity 312, the integration system 116 can provide information with respect to the individual activities. For example, in providing a presentation of the integrated report 306, the integration system 116 can provide graphical icons (e.g., selectable icons) that include information about a tracked instance of activity or customer behavior from a particular journey. For example, while not shown in FIG. 3, an icon representative of an instance of web activity may include an indicator of a document or article clicked on by a customer. The icon may include additional information such as a time that the customer clicked a link to the article, how long the article was viewed, and other information tracked by the analytics system 104. As another example, while not shown in FIG. 3, an icon representative of an instance of customer activity may include a date, a location, or other information associated with a customer's in-person visit to a store or other location at the time that a product was purchased. Indeed, each of the icons (e.g., 310, 312) may be accompanied by corresponding information tracked by the analytics system 104 and/or CRM system 108.

The integrated report 306 can include any number of individual paths or journeys tracked for corresponding customers and associated devices. In one or more embodiments, the integrated report 306 includes one or more customer journeys for which the CRM system 108 has detected a conversion (e.g., a sale) or other end-goal that a merchant, marketer, or other entity is interested in tracking. In addition, the integrated report 306 may include any number of reports that fit a particular criteria or setting (e.g., as indicated by a user of a client device or associated with a user account requesting generation of the integrated report 306).

It will be understood that the integration system 116 implemented on either the analytics system 104 or an independent client device 110 may cause the corresponding device to generate the integrated report 306. For example, a portion of the integration system 116 (e.g., the CRM data integrator 208) implemented on a client device 110 may generate an integrated report 306, store the integrated report 306, and provide a display of the integrated report 306 using an application (e.g., a data stitching application) implemented locally on the client device 110. As another example, where the integration system 116 is implemented on the analytics system 104, the client device 110 may receive the integrated report 306 via a web application or remotely accessible report generated, stored, and made accessible to the client device 110 via an interface provided by the analytics system 104.

Proceeding to FIG. 4A, the integration system 116, whether implemented on the analytics system 104 or the client device 110, may generate a comprehensive report based on one or multiple integrated reports 306 that combine the analytics data 302 and the CRM data 304 for individuals and associated customer devices. As an illustrative example, the analytics system 104 can receive (or generate using the integration system 116) a collection of integrated reports 306 and generate one or more comprehensive reports 402-404 including additional information representative of a collection of customer journeys.

As a first non-limiting example, the analytics system 104 (or integration system 116 on the analytics system 104) can generate a first comprehensive report 402 that includes a side-by-side view of trends associated with CRM data 304 and analytics data 302 For example, as shown in FIG. 4A, the first comprehensive report 402 includes plots of CRM activity data and web activity data side-by-side to view how the two types of data are correlated (or not correlated). As another example, the comprehensive report 402 may include a side-by-side view of online data (e.g., including a combination of both analytics data 302 and online customer activity from the CRM data 304) and offline data (e.g., including offline customer activity from the CRM data 304).

While not shown in FIG. 4A, the comprehensive report 402 may enable a user (e.g., of the client device 110) to interact with the report to further drill down into the specific trends of data and view correlations between the analytics data 302 and corresponding CRM data 304. For example, when provided via a graphical user interface on the client device 110, the comprehensive report may include one or more selectable icons that, when selected, provide additional information about the data shown within the comprehensive report 402.

As a second example, the analytics system 104 (or integration system 116 on the analytics system 104) can generate a second comprehensive report 404 that includes specific types or instances of web activity and corresponding CRM conversation data. For example, the analytics system 104 (or integration system 116) may implement one or more algorithms to determine or estimate a particular influence of a particular article, link, or interaction with a discrete piece of content from one or more web pages to determine a measure of influence or monetary value that the article, link, or interaction had in influencing one or more customers to make a purchase or perform other desirable behavior tracked by the CRM system 108. In this way, the integration system 116 can facilitate more accurately determining specific web activities tracked by the analytics system 104 with corresponding monetary values or customer activities as tracked by the CRM system 108.

Accordingly, it will be understood that by associating a unique visitor identifier with discrete instances of web activity and further providing instructions for tagging a lead file with the unique visitor identifier, the integration system 116 facilitates creation of various reports (e.g., integrated report 306, comprehensive reports 402, 404) that were previously impossible using traditional data tracking and integration methods. Indeed, without requiring that independent systems share proprietary data or implement common data formats or tracking protocols, the integration system 116 nonetheless facilitates associating different data sets independently tracked by different systems without requiring an extensive overhaul in tracking methods or storage of data by different systems. Furthermore, by deploying the container 220 and associated instructions 222, the integration system 116 facilitates automated association of the data to further enable integration of data and generation of comprehensive reports without adding significant processing expenses or overhead to any of the systems and devices involved.

Indeed, as a general example, the client device 110 may provide a selectable option that causes the integration system 116 to collect and integrate the analytics data and the CRM data in accordance with one or more embodiments described herein. Indeed, in response to a single user input requesting generation of an integrated or comprehensive report, the integration system 116 may associate corresponding analytics and CRM data and provide a presentation of a report in accordance with one or more embodiments preferences selected by an individual operating the client device 110.

FIG. 4B illustrates another example report 406. For example, the integration system 116 may provide a comprehensive report including a summary of metrics such as a content item with the most favorable metrics, a total number of individuals influenced by the content item, the total revenue influenced, and so forth. The presentation of the report may be provided via a dashboard on a graphical user interface of the client device 110. The presentation may also be segmented by levels of a marketing funnel (e.g., awareness, consideration, and conversion), thus allowing a client to have a single-view snapshot of all content marketing efforts.

FIG. 4C illustrates another example report 408 including a revenue influence dashboard. As shown in FIG. 4C, the example report 408 may show a total deal size and number of touches for all ongoing and closed deals. When a user of the client device 110 clicks on a deal, the report 408 may show a list of all pieces of digital content engaged with by contacts on that deal, ranked by total content touches. Additionally, the report 408 may include a summary tile of total opportunity, total revenue, and total number of touches filtered by date range, industry, or deal size. In addition, the report 408 may be filtered to show a list of the individual leads touched or otherwise influenced by digital content as well as the total number of leads influenced by and/or attributable to specific digital content items.

FIG. 4D illustrates another example report 410 including a collection of customer journeys including both CRM data and analytics data. As shown in FIG. 4D, the report may provide a visual representation of the customer journey for corresponding individuals from first touch, to lead, to opportunity, and finally to a sale or other conversion metric. The report 410 may include a visualization of a data range for one or more specific customer journeys and all possible content touches in each level of the marketing funnel. The report 410 may be filtered so as to visualize the customer journey(s) within each segment of the funnel: prior to becoming a lead, prior to becoming an opportunity, prior to closing a deal, etc.

FIG. 4E illustrates another example report 412 including a content analysis dashboard. The report 412 may include a visualization of a sort and rank for a number of digital content items classified by a web analytics stream based on a total revenue influenced by the corresponding digital content item. The content items consumed by contacts on the most high-profile or important deals may appear with a high ranking. Digital content touched only by a small number of contacts or contacts on low profile deals may appear with a lower ranking. Additionally, when a user clicks on a content item or set of content items, the report 412 may include a list of all the opportunities (e.g., in order of deal size) that engaged the specific content item. The report 412 may be filtered using a funnel slider, thus allowing a user of the client device 110 to see the top ranked web content at any stage or set of stages in a tunnel.

While one or more examples described herein relate specifically to a single analytics system 104 and a single CRM system 108 that collect data and integrate data together, the integration system 116 may additionally facilitate collection of data across a number of different analytics and CRM platforms using similar features and functionality described herein.

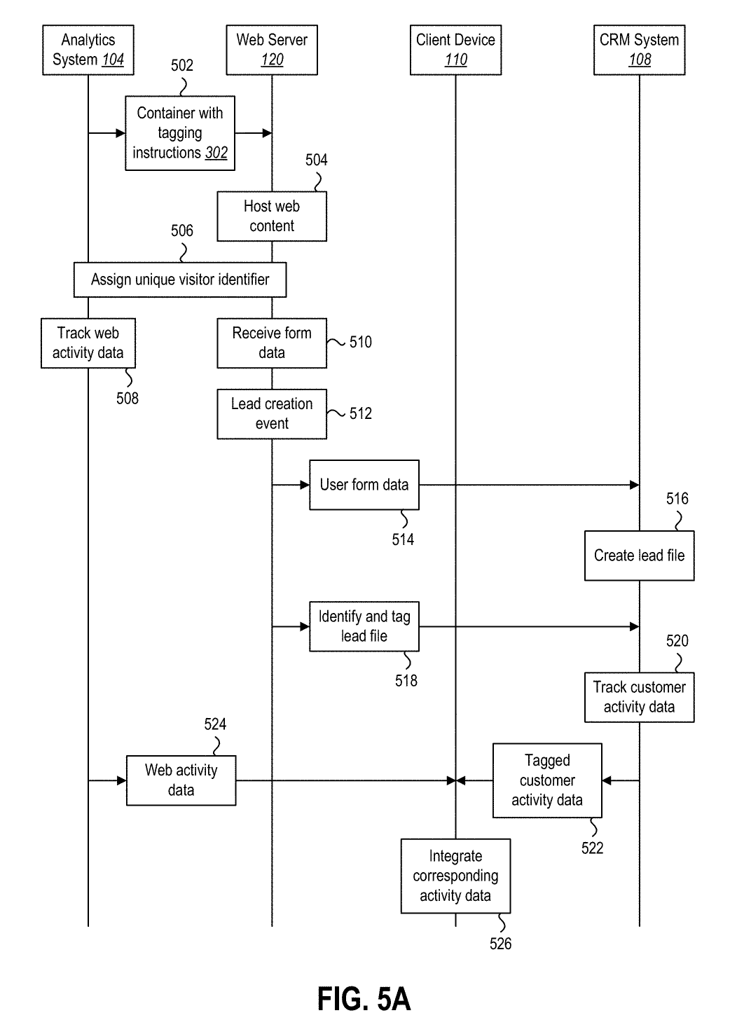

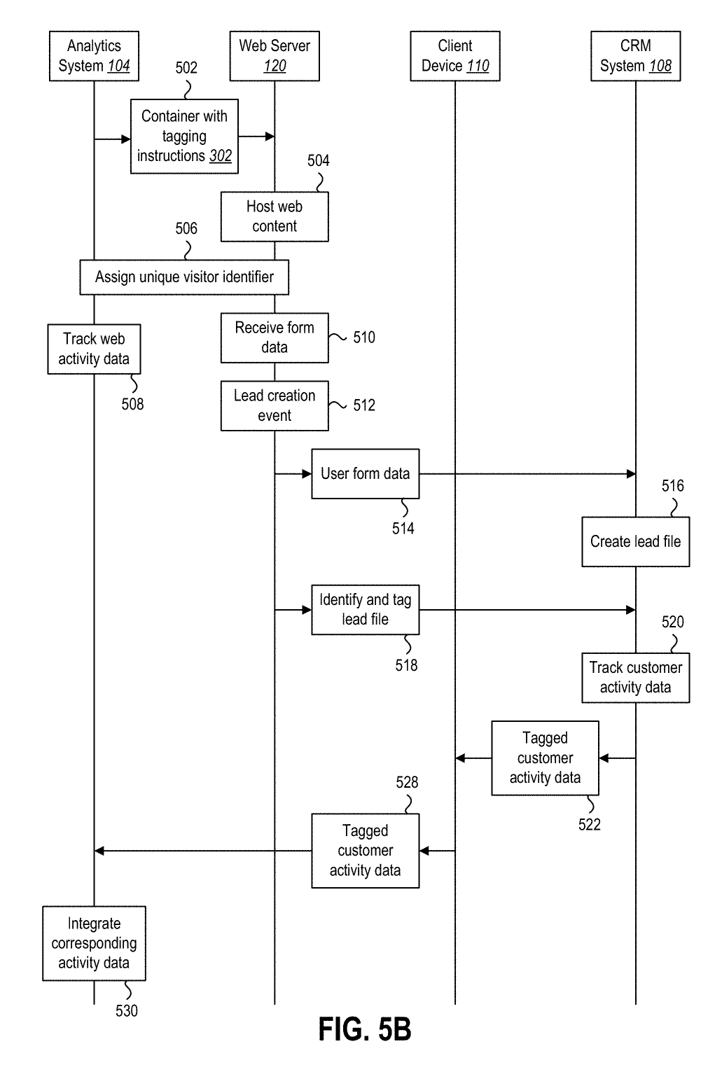

FIGS. 5A-5B illustrate sequence diagrams of interactions between devices of the environment 100 discussed above in connection with FIGS. 1-2B. In particular, FIG. 5A illustrates an example embodiment in which the integration system 116 is implemented on the client device 110 similar to one or more embodiments described in connection with FIG. 2A. FIG. 5B illustrates an example embodiment in which the integration system 116 is implemented on an analytics system 104 similar to one or more embodiments described in connection with FIG. 2B. It will be appreciated that one or more interactions shown in FIGS. 5A-5B can include similar features and functionality as described above in connection with any other embodiment.

Referring now to FIG. 5A, the analytics system 104 can perform an act 502 of deploying a container with tagging instructions to a web page 120 (or collection of web pages). In particular, the analytics system 104 can deploy a container on one or more web pages including instructions for detecting a trigger event and subsequently tagging customer activity data with a unique visitor identifier associated with web activity data tracked by the analytics system 104. In one or more embodiments, the container includes JavaScript code within the container. The instructions (e.g., the JavaScript code) may be included within the container when deployed to the web page(s). Alternatively, the instructions may be added to a container after deployment (e.g., by an administrator of the website or other individual using the client device 110).

As further shown in FIG. 5A, the web server 120 may perform an act 504 of hosting web content. The web server 120 may host the web content by hosting a collection of web pages including any number of web documents and linked digital content items (e.g., documents, images, videos, etc.) accessible to a customer device requesting web content from the web server 120.

Upon detecting a visitor to the web page, the analytics system 104 and/or web server 120 may perform an act 506 of assigning a unique visitor identifier to a customer device. For example, upon visiting a website for the first time using a customer device, the customer device may be assigned or otherwise associated with a unique visitor identifier. This unique visitor identifier may be provided to the customer device in the form of a tracking cookie or other tracking tool that enables the analytics system 104 to re-identify the customer device at subsequent visits to the website.

As discussed in one or more examples above, the unique visitor identifier may be assigned to a specific customer device using a specific web browser. Accordingly, when the customer device is used to re-visit the website while using the same web browser, the customer device may provide the visitor identifier to indicate the same pairing of device and web browser. Alternatively, where a user of the customer device uses a different customer device and/or a different web browser, a new unique visitor identifier may be assigned to the different customer device and/or web browser.

The analytics system 104 may additionally perform an act 508 of tracking web activity data. In particular, the analytics system 104 (or application running on the web server 120) can track any number of interactions by a customer device with web content hosted by the web server 120. By way of example, the analytics system 104 can track interactions including an identification of links clicked, a number of clicks, a duration of a visit to a web page, downloads, edits, online purchases, and other interactions by a customer using a customer device while visiting one or more web pages.

The web server 120 may additionally perform an act 510 of receiving form data. For example, a web page may include a user data form that enables a user of a customer device to provide personal information (e.g., registration data, login data) to provide to a CRM system 108. For instance, a user of the customer device may provide an email address, a name, an address, a login and password, or any other personal information that the CRM system 108 may use to identify a user of the customer device as a lead.

The web server 120 may also perform an act 512 of detecting a lead creation event. For example, where a user of the customer device selects a “submit” option after filling out the user data form, the instructions within the container may trigger a series of acts to associate the visitor identifier with corresponding customer activity data tracked and maintained by the CRM system 108. These series of acts may include steps for tagging a lead file with a unique visitor identifier described in further detail below.

As shown in FIG. 5A, the web server 120 can perform an act 514 of providing the user form data to the CRM system 108. Upon receiving the user form data, the CRM system 108 can perform an act 516 of creating a lead file. The lead file may include a document or other digital content file for a corresponding individual. Initially, the lead file may include the personal information provided in conjunction with the user form data. As will be discussed below, the lead file may additionally include customer activity data tracked using tools provided by the CRM system 108.

As shown in FIG. 5A, the web server 120 may additionally perform an act 518 of identifying and tagging the lead file. In particular, the web server 120 may tag a lead file with a unique visitor identifier assigned by the analytics system 104 to corresponding instances of web activity and interactions with the web content hosted by the web server 120. As discussed in one or more embodiments above, the web server 120 may tag the lead file in accordance with the instructions included within the container deployed to the web page(s) hosted by the web server 120. Indeed, the instructions, when executed, may cause the web server 120 to access an API of the CRM system 108 to identify the lead file corresponding to the user of the customer device.

The web server 120 may tag the lead file in a variety of ways. As an example, the web server 120 may access the API of the CRM system 108 to query a collection of lead files. The web server 120 may compare the personal information provided using the user data form to identify a lead file on the CRM system 108 having matching personal information. Upon identifying the correct lead file, the web server 120 may tag the lead file by adding metadata, text, or other content to the lead file that associates any information included within the lead file to the unique visitor identifier associated with the customer device. Therefore, in accordance with the instructions included within the deployed container, the web server 120 can associate the lead file with the user of the customer device.

As discussed in one or more embodiments above, the CRM system 108 may perform an act 520 of tracking customer activity data. The CRM system 108 may track online activity data and offline activity data. Upon detecting various types of customer activity data, the CRM system 108 may add the tracked activity data to the lead file for the corresponding customer.

As shown in FIG. 5A, the CRM system 108 can perform an act 522 of providing tagged customer activity data to the client device 110. For example, the CRM system 108 can provide a lead file or collection of lead files to the client device 110. The analytics system 104 may similarly perform an act 524 of providing web activity data to the client device 110. For example, the analytics system 104 can provide a collection including any quantity of tracked web activity data and associated visitor identifiers for the tracked web activity data.

Upon receiving the web activity data (e.g., the analytics data) and the customer activity data (e.g., the CRM data), the client device 110 can perform an act 526 of integrating the corresponding activity data. Integrating the activity data may include associating web activity data with corresponding customer activity data based on unique visitor identifiers associated with instances of web activity and the unique visitor identifiers tagged to respective lead files. The client device 110 may generate an integrated report that provides customer journeys for respective individuals. In addition, the client device 110 may generate comprehensive reports including trends, patterns, and other data drawn from a combination of multiple integrated reports.

FIG. 5B illustrates a similar series of acts as FIG. 5A. For example, FIG. 5B illustrates that the analytics system 104, web server 120, client device 110, and CRM system 108 can perform similar acts 502-522 as discussed above in connection with FIG. 5B. As further shown, upon receiving the customer activity data from the CRM system 108, the client device 110 can perform an act 528 of providing tagged customer activity data to the analytics system 104. Upon receiving the tagged customer activity data, the analytics system 104 (e.g., the integration system 116 implemented on the analytics system 104) may perform an act 530 of integrating corresponding activity data. For example, the analytics system 104 can generate one or more integrated reports including both web activity data and associated customer activity data based on associated unique visitor identifiers. The analytics system 104 may additionally generate one or more comprehensive reports including similar combinations of data as discussed in connection with one or more examples above.

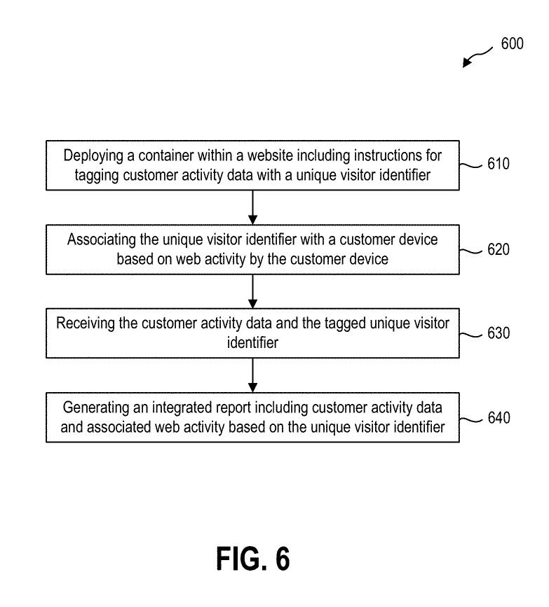

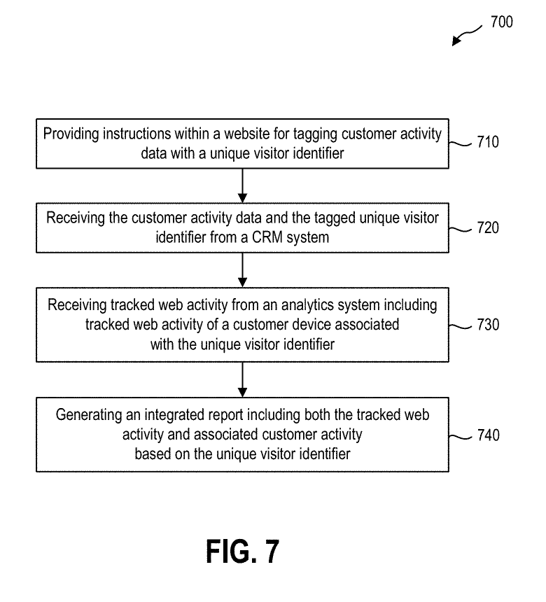

Turning now to FIGS. 6-7, these figures illustrate example flowcharts including series of acts for utilizing a unique visitor identifier to associate web activity data tracked by an analytics system and customer data tracked by a CRM system and integrating the data in accordance with one or more embodiments described herein. While FIGS. 6-7 illustrate acts according to one or more embodiments, alternative embodiments may omit, add to, reorder, and/or modify any of the acts shown in FIGS. 6-7. The acts of FIGS. 6-7 can be performed as part of a method. Alternatively, a non-transitory computer readable medium may include instructions that, when executed by one or more processors, cause a server device and/or client device to perform the acts of FIGS. 6-7. In still further embodiments, a system can perform the acts of FIGS. 6-7.

For example, a series of acts 600 may include an act 610 of deploying a container within a website including instructions for tagging customer activity data with a unique visitor identifier. In one or more embodiments, the act 610 includes deploying a container on a website where the container includes instructions for tagging customer activity data tracked by a customer relationship management (CRM) system with a unique visitor identifier associated with an analytics system.

Deploying the container may include adding the container to a website. Deploying the container may additionally include adding instructions within the container. For example, deploying the container may include providing JavaScript code within the container including the instructions.

In one or more embodiments, the analytics system is implemented on a first one or more server devices. The CRM system may be implemented on a second one or more server devices independent from the first one or more server devices. Indeed, the first and second server device(s) may be owned, operated, or otherwise managed by independent entities.

The series of acts 600 may further include an act 620 of associating the unique visitor identifier with a customer device based on web activity by the customer device. For example, in one or more embodiments, the act 620 includes associating the unique visitor identifier with a customer device based on detecting one or more web activities by the customer device with respect to content of the website. Associating the unique visitor identifier with the customer device may include generating the unique visitor identifier in response to detecting a first activity by the customer device with respect to the website. Associating the unique visitor identifier with the customer device may further involve including the unique identifier within a tracking cookie downloaded to the customer device to enable the analytics system to associate subsequent web activity by the customer device with the visitor identifier.

As indicated above, the container deployed to the website may include instructions therein. The instructions may cause the web server to detect an event that triggers creation of a lead file by the CRM system where the lead file includes the customer activity data. The instructions may further cause the web server to identify the unique visitor identifier associated with the customer device and identify a customer identifier entered by a user of the customer device. The instructions may further cause the web server to query a plurality of lead files created by the CRM system to identify the lead file having the customer identifier entered by the user of the customer device and add the unique visitor identifier associated with the customer device to the identified lead file having the customer identifier. In one or more embodiments, querying the plurality of lead files and adding the unique visitor identifier are performed by accessing an application programming interface (API) of the CRM system.

The series of acts 600 may further include an act 630 of receiving the customer activity data and the tagged unique visitor identifier. For example, the act 630 may include receiving the customer activity data tracked by the customer relationship management (CRM) system and the unique visitor identifier tagged to the customer activity data based on the instructions included within the container. In one or more embodiments, the customer activity data includes offline activity tracked and maintained by the CRM system. The customer activity data may additionally include online activity by the customer device tracked by the CRM system where the online activity includes instances of online activity by the customer device with respect to one or more additional websites independent from the website including the container.

The series of acts 600 may additionally include an act 640 of generating an integrated report including customer activity data and associated web activity based on the unique visitor identifier. For example, the act 640 may include generating an integrated report including information associated with the customer activity data tagged with the unique identifier and corresponding one or more web activities by the customer device with respect to content of the website associated with the unique visitor identifier.

In one or more embodiments, the series of acts 600 includes associating a second unique visitor identifier with a second customer device. The container may additionally include instructions that, when executed by at least one processor of the web server hosting the website, cause the web server to determine that the second unique visitor identifier is associated with a user of the customer device and associate the second unique identifier with the user of the customer device by tagging the customer activity data tracked by the CRM system with the second unique identifier to the lead file.

FIG. 7 illustrates another series of acts 700. As shown in FIG. 7, the series of acts 700 may include an act 710 of providing instructions within a website for tagging customer activity data (e.g., a lead file) with a unique visitor identifier. For example, the act 710 may include providing, within a container deployed via a website, instructions for tagging customer activity data with a unique visitor identifier associated with an analytics system where the customer activity data is tracked by a customer relationship management (CRM) system independent from the analytics system. Providing the instructions may include providing JavaScript code within the container including the instructions.

The series of acts 700 may further include an act 720 of receiving the customer activity data and the tagged unique visitor identifier from a CRM system. For example, the act 720 may include receiving, from the CRM system, the customer activity data and the unique visitor identifier tagged to the customer activity data based on the instructions provided within the container.

The series of acts 700 may additionally include an act 730 of receiving tracked activity from an analytics system including tracked web activity of a customer device associated with the unique visitor identifier. The act 730 may include receiving, from the analytics system, web activity data for a customer device with respect to content of the website, wherein the web activity data is associated with a visitor identifier assigned to the customer device by the analytics system.

Moreover, the series of acts 700 may include an act 740 of generating an integrated report including both the tracked web activity and associated customer activity based on the unique visitor identifier. For example, the act 740 may include generating an integrated report including both the web activity data with respect to content of the website associated with the unique visitor identifier and corresponding customer activity data tagged with the unique visitor identifier.

FIG. 8 illustrates certain components that may be included within a computer system 800. One or more computer systems 800 may be used to implement the techniques disclosed herein, such as the series of acts 600, 700 described above in connection with FIGS. 6 and 7.

The computer system 800 includes a processor 801. The processor 801 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the methods disclosed herein. Executing the instructions 805 may involve the use of the data 807 that is stored in the memory 803. When the processor 801 executes the instructions 805, various portions of the instructions 805a may be loaded onto the processor 801, and various pieces of data 807a may be loaded onto the processor 801.

Any of the various examples of modules and components described herein, such as a cross-functional analytics tool, may be implemented, partially or wholly, as instructions 805 stored in memory 803 and executed by the processor 801. Any of the various examples of data, values, or information described herein may be among the data 807 that is stored in memory 803 and used during execution of the instructions 805 by the processor 801.

The computer system 800 may also include one or more communication interfaces 809 for communicating with other electronic devices. The communication interfaces 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker, printer, etc. One specific type of output device that is typically included in a computer system is a display device. Display devices used with embodiments disclosed herein may utilize any suitable image projection technology, such as liquid crystal display (LCD), light-emitting diode (LED), gas plasma, electroluminescence, or the like. A display controller may also be provided, for converting data 807 stored in the memory 803 into text, graphics, and/or moving images (as appropriate) shown on the display device.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
deploying a container on a website, the container including instructions for tagging customer activity data tracked by a customer relationship management (CRM) system with a unique visitor identifier associated with an analytics system;
associating the unique visitor identifier with a customer device based on detecting one or more web activities by the customer device with respect to content of the web site;
receiving the customer activity data tracked by the customer relationship management (CRM) system and the unique visitor identifier tagged to the customer activity data based on the instructions included within the container; and
generating an integrated report including information associated with the customer activity data tagged with the unique visitor identifier and corresponding one or more web activities by the customer device with respect to content of the website associated with the unique visitor identifier.

2. The method of claim 1, wherein deploying the container including the instructions for tagging the customer activity data with the unique visitor identifier comprises:
adding the container to the web site; and
providing JavaScript code within the container including the instructions.

3. The method of claim 1, wherein the analytics system is implemented on a first one or more server devices and the CRM system is implemented on a second one or more server devices independent from the first one or more server devices.

4. The method of claim 1, wherein associating the unique visitor identifier with the customer device comprises:
generating the unique visitor identifier in response to detecting a first activity by the customer device with respect to the website; and
including the unique visitor identifier within a tracking cookie downloaded to the customer device to enable the analytics system to associate subsequent web activity by the customer device with the unique visitor identifier.

5. The method of claim 1, wherein the instructions included within the container, when executed by at least one processor of a web server hosting the website, cause the web server to:
detect an event that triggers creation of a lead file by the CRM system, wherein the lead file includes the customer activity data;
identify the unique visitor identifier associated with the customer device; and
identify a customer identifier entered by a user of the customer device.

6. The method of claim 5, wherein the instructions, when executed by the at least one processor of the web server, further cause the web server to:
query a plurality of lead files created by the CRM system to identify the lead file having the customer identifier entered by the user of the customer device; and
add the unique visitor identifier associated with the customer device to the identified lead file having the customer identifier.

7. The method of claim 6, wherein querying the plurality of lead files and adding the unique visitor identifier are performed by accessing an application programming interface (API) of the CRM system.

8. The method of claim 1, wherein the customer activity data includes offline activity tracked and maintained by the CRM system.

9. The method of claim 8, wherein the customer activity data additionally includes online activity by the customer device tracked by the CRM system, the online activity comprising instances of online activity by the customer device with respect to one or more additional websites independent from the website including the container.

10. The method of claim 1, further comprising:
associating a second unique visitor identifier with a second customer device;
wherein the instructions included within the container, when executed by at least one processor of a web server hosing the website, cause the web server to:
determine that the second unique visitor identifier is associated with a user of the customer device; and
associate the second unique visitor identifier with the user of the customer device by tagging the customer activity data tracked by the CRM system with the second unique identifier.

11. A method, comprising:
providing, within a container deployed via a website, instructions for tagging customer activity data with a unique visitor identifier associated with an analytics system, wherein the customer activity data is tracked by a customer relationship management (CRM) system independent from the analytics system;
receiving, from the CRM system, the customer activity data and the unique visitor identifier tagged to the customer activity data based on the instructions provided within the container;
receiving, from the analytics system, web activity data for a customer device with respect to content of the website, wherein the web activity data is associated with a visitor identifier assigned to the customer device by the analytics system; and
generating an integrated report including both the web activity data with respect to content of the website associated with the unique visitor identifier and corresponding customer activity data tagged with the unique visitor identifier.

12. The method of claim 11, wherein providing instructions within the container deployed via the website comprises providing JavaScript code within the container including the instructions.

13. The method of claim 11, wherein the analytics system is implemented on a first one or more server devices and the CRM system is implemented on a second one or more server devices independent from the first one or more server devices.

14. The method of claim 11, wherein the instructions included within the container, when executed by at least one processor of a web server hosting the website, cause the web server to:
detect an event that triggers creation of a lead file by the CRM system, wherein the lead file includes the customer activity data;
identify the unique visitor identifier associated with the customer device; and
identify a customer identifier entered by a user of the customer device.

15. The method of claim 14, wherein the instructions, when executed by the at least one processor of the web server, further cause the web server to:
query a plurality of lead files created by the CRM system to identify the lead file having the customer identifier entered by the user of the customer device; and
add the unique visitor identifier associated with the customer device to the identified lead file having the customer identifier.

16. The method of claim 15, wherein querying the plurality of lead files and adding the unique visitor identifier are performed by way of an application programming interface (API) of the CRM system.

17. The method of claim 11, wherein the customer activity data includes offline activity tracked and maintained by the CRM system.

18. The method of claim 17, wherein the customer activity data additionally includes online activity by the customer device tracked by the CRM system, the online activity comprising instances of online activity by the customer device with respect to one or more additional websites independent from the website including the container.

19. A system comprising:
one or more processors; and
a non-transitory computer readable medium storing instructions thereon that, when executed by the one or more processors, cause the system to:
provide, within a container deployed via a website, instructions for tagging customer activity data with a unique visitor identifier associated with an analytics system, wherein the customer activity data is tracked by a customer relationship management (CRM) system independent from the analytics system;
receive, from the CRM system, the customer activity data and the unique visitor identifier tagged to the customer activity data based on the instructions provided within the container;
receive, from the analytics system, web activity data for a customer device with respect to content of the web site, wherein the web activity data is associated with a visitor identifier assigned to the customer device by the analytics system; and
generate an integrated report including both the web activity data with respect to content of the website associated with the unique visitor identifier and corresponding customer activity data tagged with the unique visitor identifier.

20. The system of claim 19, wherein the instructions included within the container, when executed by at least one processor of a web server hosting the website, cause the web server to:
detect an event that triggers creation of a lead file by the CRM system, wherein the lead file includes the customer activity data;
identify the unique visitor identifier associated with the customer device;
identify a customer identifier entered by a user of the customer device;
query a plurality of lead files created by the CRM system to identify the lead file having the customer identifier entered by the user of the customer device; and
add the unique visitor identifier associated with the customer device to the identified lead file having the customer identifier.
